(19) United States
(12) Patent Application Publication
(10) Pub. No.: US 2025/0067590 A1
(43) Pub. Date: Feb. 27, 2025

(54) FLOODING WATER LEVEL MONITORING METHOD AND SYSTEM FOR ELECTRIC POWER FACILITIES

(71) Applicant: Electric Power Science Research Institute of Guangxi Power Grid Co., Ltd., Nanning (CN)

(72) Inventors: Shan LI, Nanning (CN); Wei ZHANG, Nanning (CN); Yangjun ZHOU, Nanning (CN); Wei HUANG, Nanning (CN); Jianna OUYANG, Nanning (CN); Yu ZOU, Nanning (CN); Bin FENG, Nanning (CN); Yangsheng LIU, Nanning (CN); Liwen QIN, Nanning (CN)

(21) Appl. No.: 18/944,533

(22) Filed: Nov. 12, 2024

Related U.S. Application Data
(63) Continuation of application No. PCT/CN2023/121447, filed on Sep. 26, 2023.

(30) Foreign Application Priority Data
Nov. 3, 2022 (CN) 2022113712174

(51) Int. Cl. G01F 23/80

(52) U.S. Cl. CPC G01F 23/804

(57) ABSTRACT

The present invention discloses a flooding water level monitoring method and system for power facilities, including after receiving a flooding emergency response notification and a heavy rainfall defense alarm, starting facility flooding water level monitoring; and based on the individual area and total area of facilities affected by flooding and water level sensing monitoring information, establishing a neural network measuring an affected range, and outputting the monitoring result of a flooded surface height in a region, thereby achieving all-weather real-time monitoring, and accurately measuring and timely reporting a flooding height.

### CROSS-REFERENCE TO RELATED APPLICATIONS

The present application claims priority to Chinese Patent Application No. 2022113712174, filed on Nov. 3, 2022, the entire disclosure of which is incorporated herein by reference.

### TECHNICAL FIELD

The present invention relates to the technical field of power disaster prevention and mitigation, and in particular relates to a flooding water level monitoring method and system for power facilities.

### BACKGROUND

Natural disasters such as heavy rainfall and floods have a serious impact on power facilities, and may even evolve into large-scale power outages. Affected by geographical locations, climatic conditions and topography, a current disaster prevention and mitigation mode used to resist flooding against power facilities needs to be improved in terms of timeliness and accuracy of early warning, which not only affects command decision-making, but also has personnel operation risks and public safety risks related to electricity. At the same time, in case of large-scale disaster losses, the effectiveness and timeliness of rush repair of electric power also directly affects the reliable supply of electricity and social and economic development.

While facing the increasing frequency of natural disasters such as floods, flash floods and geological disasters in small and medium-sized rivers caused by heavy rainfall and the expanding scale of power grids, it is extremely important to focus on extreme natural disasters and key affected regions, strengthen monitoring, forecasting and early warning, and build the first line of defense for disaster prevention and mitigation.

In view of this, a flooding water level monitoring method and system for power facilities are required.

### SUMMARY

An embodiment of the present invention provides a flooding water level monitoring method and system for power facilities, to at least solve the technical problem that a current disaster prevention and mitigation mode used to resist flooding against power facilities needs to be improved in terms of timeliness and accuracy of early warning in the related art.

According to an aspect of the embodiment of the present invention, a flooding water level monitoring method for power facilities is provided, including:
after receiving a flooding emergency response notification and a heavy rainfall defense alarm, starting a flooding water level monitoring process for power facilities;
inputting the flooding emergency response notification and the heavy rainfall defense alarm, judging whether a power facility region is affected, and when the power facility region is affected, issuing an early warning notification, and taking a next step;
inputting a power geographic information map, determining the boundary range at the location of the power facilities belonging to a water-logging region, and calculating the individual area of the power facilities and the total area of the power facilities affected by flooding;
inputting water level sensing monitoring information of a power facility body affected by flooding; and
according to the individual area of the power facilities, the total area of the power facilities and the water level sensing monitoring information of the power facility body affected by flooding, establishing a neural network measuring an affected range of the power facility region, and outputting the flooded surface height monitoring result at the location of the power facilities.

Optionally, the flooded surface height monitoring result at the location of the power facilities includes: the individual area, the total area, the flooded surface height, the flooding time and the affected level at the location of the power facilities affected by flooding.

Optionally, whether the power facility region is affected is judged according to the flooding emergency response notification, the heavy rainfall defense alarm information and the flood risk map in the flooding emergency response notification and the heavy rainfall defense alarm.

Optionally, the water level sensing monitoring information of the power facility body is obtained through measurement of a liquid level sensor.

Optionally, the expression that the neural network measuring the affected range of the power facility region calculates the flooded surface height Ē at the location of the power facilities is:

$$\overline{E} = \frac{1}{{S}_{n}} \sum {μ}_{i} {E}_{i} {dS}_{i}$$

In the expression, Sn refers to the total area of the power facilities affected by flooding, dSᵢ refers to the individual area of the power facilities affected by flooding, Eᵢ refers to the flooding height of the power facilities, and μᵢ refers to the weight of different region types.

Optionally, the weight corresponding to μᵢ is set according to the accuracy level of the liquid level sensor.

Optionally, the affected level of the region is determined according to the flooded surface height of the power facilities affected by flooding.

According to another aspect of the embodiment of the present invention, a flooding water level monitoring method for power facilities is also provided, including:
a safety access layer, for receiving a flooding emergency response notification and a heavy rainfall defense alarm issued on the website of a local flood control and drought relief headquarter, and water level sensing monitoring information of a power facility body;
an acquisition layer, for acquiring relevant information of a power geographic information map;
a data layer, for storing data processed by the flooding water level monitoring system for power facilities;
a processing layer, for after receiving the flooding emergency response notification and the heavy rainfall defense alarm, starting a flooding water level monitoring process for power facilities; according to the flooding emergency response notification and the heavy rainfall defense alarm, judging whether a power facility region is affected, and when the power facility region is affected, issuing an early warning notification, and taking a next step; according to the electric power geographic information map, determining the boundary range at the location of the power facilities belonging to a water-logging region, and calculating the individual area of the power facilities and the total area of the power facilities affected by flooding; according to the individual area of the power facilities and the total area of the power facilities affected by flooding and the water level sensing monitoring information of the power facility body, establishing a neural network measuring an affected range of the power facility region, and outputting the flooded surface height monitoring result at the location of the power facilities; and
an application layer, for displaying the flooded surface height monitoring result at the location of the power facilities and relevant data output by the processing layer, and carrying out data transmission through a website server.

According to another aspect of the embodiment of the present invention, a computer readable storage medium is also provided, the computer readable storage medium includes a stored program, wherein the program, when running, controls equipment with the computer readable storage medium to execute the flooding water level monitoring method for power facilities according to any one of the claims.

Compared with the prior art, the present invention has the following beneficial effects:

In the embodiment of the present invention, the flooding water level monitoring method and system for power facilities provided by the present invention, include a solving method of a flooding height of an affected power facility region (flooding height, degree and time solving model of the affected power facility region) and a flooding characteristic monitoring system at the location of the power facilities (a safety access layer, an acquisition layer, a data layer, a processing layer and an application layer).

The method and system creatively realize the function of all-weather real-time monitoring on the affected power facility region based on hydrological release data and water level monitoring data, and overcome difficulties in measuring the flooded surface height at the location of the power facilities, having good timeliness and accuracy for the flooding height, degree and time monitoring results at the location of the power facilities affected by flooding, facilitating the production command center to guide emergency early warning, load transfer, flood control reinforcement, emergency repair of electric power, material allocation, customer service, grid planning, and the like, and greatly reducing the outage time of power facilities and user outage time.

### BRIEF DESCRIPTION OF DRAWINGS

In order to describe the technical solutions of the embodiments of the present invention more clearly, the drawings required to be used in the description for the embodiments will be introduced briefly below, apparently, the drawings in the description below show merely some embodiments of the present invention, and those of ordinary skill in the art may also derive other drawings from these drawings without making creative efforts.

FIG. 1 is a flowchart of a flooding water level monitoring method for power facilities according to an embodiment of the present invention;

FIG. 2 is a structural schematic diagram of a neural network measuring the affected range of a power facility region according to an embodiment of the present invention; and

FIG. 3 is a schematic diagram of a flooding water level monitoring system for power facilities according to an embodiment of the present invention.

### DETAILED DESCRIPTION OF THE EMBODIMENTS

It is to be noted that the embodiments and features in the embodiments of the present application may be combined with each other without conflict. The present application will be described below in detail with reference to drawings and in conjunction with the embodiments.

In order to enable those skilled in the art to better understand the solutions of the present application, the technical solutions in the embodiments of the present invention will be clearly and completely described below in conjunction with the accompanying drawings in the embodiments of the present invention. Apparently, the described embodiments are only part rather than all of the embodiments of the present invention. On the basis of the embodiments in the present application, all other embodiments acquired by those of ordinary skilled in the art without creative efforts fall within a protection scope of the present application.

It should be noted that the terms “first”, “second”, and the like in the present application, the claims, and the drawings of the present invention are used to distinguish between similar objects and not necessarily to describe a specific sequence or order. It should be understood that such used data is interchangeable under appropriate circumstances, such that the embodiments of the present application described herein. Moreover, the terms “including/comprising” and “having” as well as any variations thereof are intended to mean covered and non-exclusive inclusion, for example, a process, a method, a system, a product or an apparatus including a series of steps or units does not need to be limited by those explicitly listed, but may include other steps or units not explicitly listed or inherent to these processes, methods, products or apparatuses.

### Embodiment 1

According to the embodiment of the present invention, an embodiment of a flooding water level monitoring method for power facilities is provided. It should be noted that the steps shown in the flowchart in the drawings can be executed in a computer system such as a set of computer executable instructions, and although the logical order is shown in the flowchart, in some cases, the steps shown or described can be executed in a different order from here.

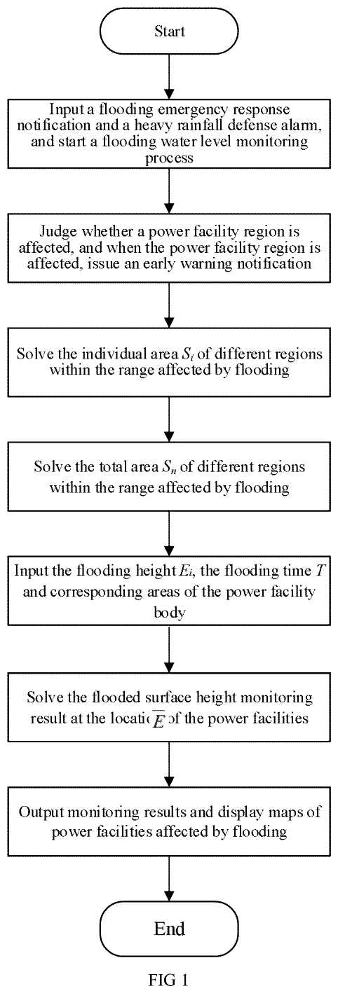

FIG. 1 is a flowchart of a flooding water level monitoring method for power facilities according to the embodiment of the present invention. As shown in FIG. 1, the method includes the following steps:

S10, after receiving a flooding emergency response notification and a heavy rainfall defense alarm, starting a flooding water level monitoring process for power facilities.

As an optional embodiment, the flooding emergency response notification and the heavy rainfall defense alarm are received from a power grid company production command center. The flooding emergency response notification and the heavy rainfall defense alarm are information issued on the website of a local flood control and drought relief headquarter.

S20, inputting the flooding emergency response notification and the heavy rainfall defense alarm, judging whether a power facility region is affected, and when the power facility region is affected, issuing an early warning notification, and taking a next step;

As an optional embodiment, whether the power facility region is affected is judged according to the flooding emergency response notification, the heavy rainfall defense alarm information and the flood risk map about a power supply region in the flooding emergency response notification and the heavy rainfall defense alarm, and the early warning notification issued includes the emergency response level of flooding water level monitoring at the location of the power facilities.

The power supply region includes a power supply region of a prefecture-level power supply bureau and a power supply region of a county-level power supply bureau.

The flood risk map refers to a map of spatial distribution of flood risk element information.

As an optional embodiment, the power facilities include: generators, transformers, reactors, circuit breakers, current transformers, voltage transformers, isolating switches, arresters, coupling capacitors, wave arresters, overhead lines, cable lines, combined electrical appliances, bus equipment and facilities thereof. The location of the power facilities includes: power plants, transmission corridors, substations, and affected power facility regions.

The flooding emergency response notification and the heavy rainfall defense alarm information include: emergency response levels, early warning regions and precipitations. Precipitations refer to the depth (mm) of rain falling from the sky to the ground without evaporation, infiltration and loss but accumulated on the horizontal plane, specifically, including: regional precipitation (mm), local maximum precipitation (mm) and maximum hourly precipitation (mm).

As an optional embodiment, the emergency response levels of flooding water level monitoring in the region of the power facilities in the early warning notification includes: level I, level II, level III and level IV, in a total of four levels.

Specifically, level I emergency response refers to the possibility of serious flooding in the basin or large-scale heavy flooding; or a hydrological department forecasts a 50-year or more than 50-year flood in a major river, or a 20-year or more than 20-year flood in two or more major rivers at the same time, or a 50-year or more than 50-year flood in important tributaries of several major rivers.

Level II emergency response refers to a rainstorm red warning issued by a meteorological department that a wide range of serious flooding or a large range of heavy flooding may be caused; or the hydrological department of a district forecasts a 20-year or more flood in a major river, or a 10-year or more than 10-year flood in two or more major rivers at the same time, or a 20-year or more than 20-year flood in important tributaries of several major rivers.

Level III emergency response refers to a rainstorm orange warning issued by the meteorological department that a wide range of serious flooding may be caused; or the hydrological department forecasts a 10-year to 20-year flood in a major river, or a more than 10-year flood in important tributaries of several major rivers.

Level IV emergency response refers to a rainstorm blue or yellow warning issued by the meteorological department that local heavy flooding may be caused; or the hydrological department forecasts a 5-year to 10-year flood in a main river, or a 5-year or more than 5-year flood in important tributaries of several major rivers.

The flood includes: storm flood, torrential flood, snowmelt flood, ice flood and dam bursting flood. Rainfall includes: light rainfall (occasional drizzles), sprinkle, moderate rain, heavy rain, rainstorm, downpour and heavy downpour, in a total of seven levels.

The above emergency response levels are divided with reference to the Flooding Emergency Plan in Guangxi Zhuang Autonomous Region in the Emergency Plan for Typhoon Flooding and Drought in Guangxi. Through the division of the emergency response levels, the present invention is more universal and practical, being convenient for the popularization and application of the patent technology.

S30, inputting a power geographic information map, determining the boundary range at the location of the power facilities belonging to a water-logging region, and calculating the individual area Sᵢ of the power facilities and the total area Sₙ of the power facilities affected by flooding;

As an optional embodiment, while calculating the individual area Sᵢ of the power facilities and the total area Sₙ of the power facilities affected by flooding, the individual area and the total area are displayed.

As an optional embodiment, the electric power geographic information map is from a power geographic information system.

As an optional embodiment, the boundary range at the location of the power facilities belonging to the water-logging region refers to a water-logging region directly reflecting flooding in a corresponding flood risk map, for example, grids of a flooding depth greater than 0.15 m.

As an optional embodiment, calculating the individual area Sᵢ of the power facilities and the total area Sₙ of the power facilities affected by flooding, includes:
under the spatial association rules, comparing the flood risk map, and judging whether the region A (Cᵤ, Cᵥ) of the power facilities in the power geographic information map is in a flooding region B (Cₓ, C_{y}) in the flood risk map. If so, the expression that the region of the power facilities belongs to the boundary range of the water-logging region, is:

$$A ( {C}_{u} , {C}_{v} ) ⇔ B ( {C}_{x} , {C}_{y} )$$

As an optional embodiment, the expression that the individual area Sᵢ of the power facilities affected by flooding is a boundary range area of an individual water-logging region at the location of the power facilities, and the total area Sₙ of the power facilities affected by flooding is the sum of all n individual areas Sᵢ of power regions affected by flooding, is:

$${S}_{n} = Δ {\sum }_{i}^{n} {S}_{i}$$

S40, inputting water level sensing monitoring information of an electric power facility body affected by flooding;

As an optional embodiment, the water level sensing monitoring information of the electric power facility is obtained through measurement of a liquid level sensor.

Specifically, the liquid level sensor refers to a sensor measuring the pressure at the location of a pressure sensing part of the sensor in a liquid medium to reckon a liquid level (including water level) height.

The liquid level sensor includes: piezoresistive liquid level sensors, capacitive liquid level sensors, inductive liquid level sensors and strain resistance liquid level sensors.

Output modes of the liquid level sensor are analog output, digital output and analog and digital mixed output, in a total of three modes. Analog output refers to that an output signal is a direct-current current or direct-current voltage signal; digital output refers to that the output signal is a digital signal; and mixed output refers to that in addition to output of an analog output signal, a digital signal is also modulated on the signal.

S50, according to the individual area of the power facilities, the total area of the power facilities and the water level sensing monitoring information of the power facility body affected by flooding, establishing a neural network measuring an affected range of the power facility region, and outputting the flooded surface height monitoring result at the location of the power facilities. The flooded surface height monitoring result at the location of the power facilities includes: the individual area, the total area, the flooded surface height, the flooding time and the affected level at the location of the power facilities affected by flooding. And displaying the flooded surface height monitoring result at the location of the power facilities through graphs.

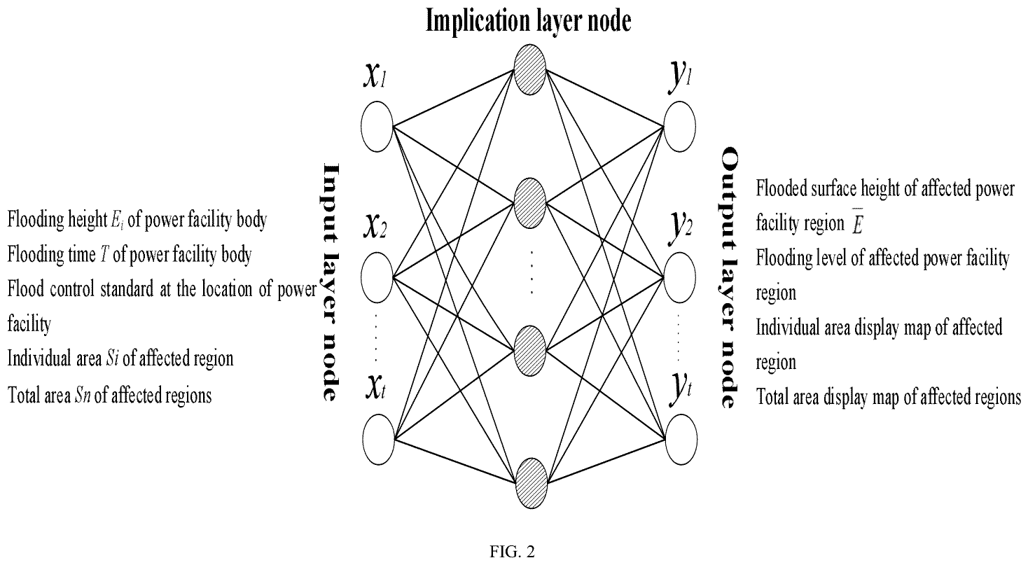

As an optional embodiment, as shown in FIG. 2, the established neural network measuring the affected range of the power facility region includes: an input layer, an implication layer and an output layer, and the whole network is a multi-input and multi-output neural network.

As an optional embodiment, an input layer node x includes: a flooding emergency response notification and a heavy rainfall defense alarm issued on the website of a flood control and drought relief headquarter, liquid level sensing information of the power facility body, power plants, transmission corridors and substations affected by flooding, and the individual area Sᵢ of the affected power facility region and the total area Sₙ of the affected power facility region.

As an optional embodiment, the implication layer is used for solving the liquid level sensing monitoring information of a flooding height Eᵢ at the location of the power facilities.

Specifically, for sampling points in the affected power facility region, a Tyson polygon including each liquid level monitoring sampling point in the affected power facility region is acquired through the power geographic information map (including graphic codes) of a power geographic information system and the liquid level sensing monitoring information of the power facilities, and the flooded surface height Ē of the region can be obtained, that is, the liquid level sensing monitoring information of the flooded surface height Eᵢ at the location of the power facilities can be obtained by multiplying and summing the flooding height Eᵢ the weight μᵢ and the area dSᵢ of each polygon of the monitoring sampling point i in the affected power facility region, and dividing by the total area of the affected power facility region.

The expression of the flooded surface height Ē at the location of the power facilities is:

$$\overline{E} = \frac{1}{{S}_{n}} \sum {μ}_{i} {E}_{i} {dS}_{i}$$

In the expression, Sₙ refers to the total area of the power facilities affected by flooding, dSᵢ refers to the individual area of the power facilities affected by flooding (that is, the area of a polygon region of the power facilities), Eᵢ refers to the flooding height of the power facilities, and μᵢ refers to the weight of different region types. The weight corresponding to μᵢ is set according to the accuracy level of the liquid level sensor.

Specifically, the accuracy levels of the liquid level sensor include 0.05, 0.1, 0.25, 0.5, 1, 2.5 and 5, in a total of seven levels, as shown in FIG. 1.

TABLE 1
Main Indicators of Different Accuracy
Levels of the Liquid Level Sensor

| Accuracy levels | 0.05 | 0.1 | 0.25 | 0.5 | 1 | 2.5 | 5 |
|---|---|---|---|---|---|---|---|
| Repeatability | ≤0.02 | ≤0.05 | ≤0.10 | ≤0.25 | ≤0.5 | ≤1.0 | ≤2.5 |
| (% FS) | | | | | | | |
| Accuracy | ±0.05 | ±0.1 | ±0.25 | ±0.5 | ±1.0 | ±0.25 | ±0.5 |
| (% FS) | | | | | | | |

Correspondingly, the weight corresponding to μᵢ is set according to the accuracy level of the liquid level sensor, and is set to 0.995, 0.990, 0.975, 0.950, 0.90, 0.750, and 0.50 according to the seven accuracy levels from high to low.

Specifically, the power facility regions and graphic codes are power plant 1000000, transmission corridor 3010000, substation 2000000, and power supply region 6030000, respectively.

In addition, the implication layer is also used for solving the flooded surface height Ē level at the location of the power facilities.

Specifically, a local flood control standard [recurrence interval (year)] that the flooded surface height Ē at the location of the power facilities reaches is compared, and furthermore five flooding levels at the location of the power facilities are determined. Comparison standards are as shown in FIG. 2.

TABLE 2
Comparison standards

| Flooded surface | |
|---|---|
| height levels | Corresponding flood control standards |
| I | Reaching 100 recurrence interval (year) |
| II | Reaching 50 recurrence interval (year) |
| III | Reaching 30 recurrence interval (year) |
| IV | Reaching 10 recurrence interval (year) |
| V | Shorter than 10 recurrence interval (year) |

When the flooded surface height level reaches the corresponding level V flood control standard, the corresponding monitoring time T is the flooding time T of the affected power facility region.

As an optional embodiment, the result output by the output layer includes: the flooded surface height Ē and the flooding time T monitoring result of the affected power facility region, a real-time map of the individual area Sᵢ and the total area Sₙ of each corresponding affected power facility is displayed, and a real-time monitoring result display map about power facility flooding water levels is issued with reference to provisions of QX/T 549 Meteorological Disaster Early Warning Information Website Communication Specifications.

As an optional embodiment, the output layer is used for outputting the display map of the flooded surface height Ē and the flooding time T of the affected power facility region in real time.

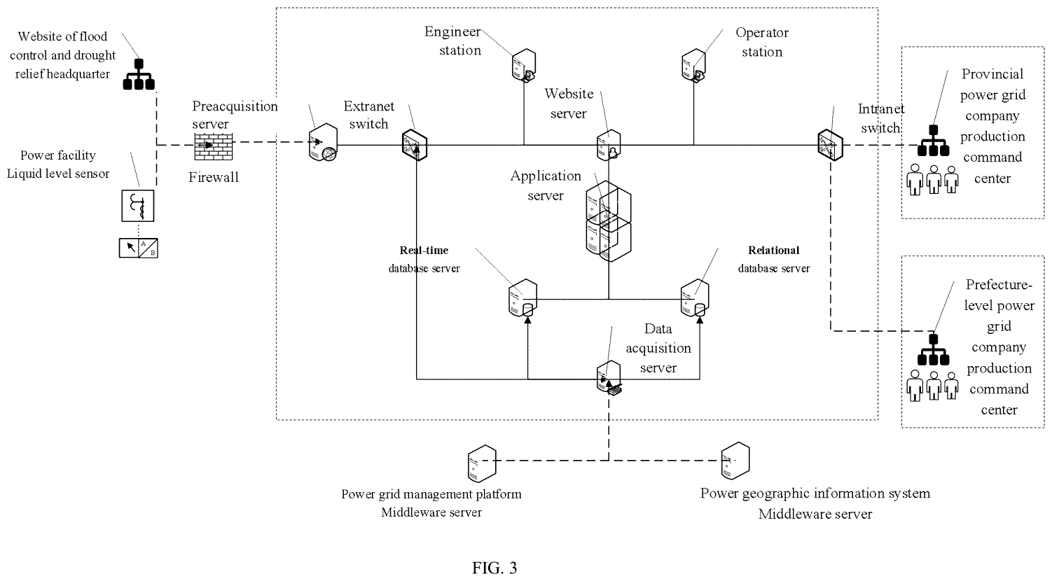

As an optional embodiment, the color system format of graph elements of the flooded surface height Ē of the affected power facility region is as shown in FIG. 3.

TABLE 3
Color System Format of Graphic Elements of Flooding Levels

| | |
|---|---|
| Flooded surface | Color system format |

| height levels | C | M | Y | K |
|---|---|---|---|---|
| I | 80 | 50 | 0 | 5 |
| II | 80 | 50 | 0 | 20 |
| III | 65 | 50 | 0 | 0 |
| IV | 50 | 40 | 0 | 0 |
| V | 30 | 20 | 0 | 0 |

### Embodiment 2

According to another aspect of the embodiment of the present invention, a flooding water level monitoring system for power facilities is also provided. The system is applied to a flooding water level monitoring method for power facilities, wherein a monitoring system covering power facilities of provincial power grids, prefecture-level power grids and county-level power grids, and the flooding height, the flooding degree and the flooding time of the affected power facility region is established, the software quality of the system meets provisions of GB/T 16260.1 Software Engineering Product Quality Part 1: Quality Model, GB/T 1 6260.2 Software Engineering Product Quality Part 2: Internal Metrics, GB/T 1 6260.3 Software Engineering Product Quality Part 3: External Metrics, and GB/T 1 6260.4 Software Engineering Product Quality Part 4: Quality in Use Metrics, and the hierarchy of the system includes a safety access layer, an acquisition layer, a data layer, a processing layer and an application layer.

As an optional embodiment, the safety access layer is used for receiving the flooding emergency response notification and the heavy rainfall defense alarm issued on the website of the local flood control and drought relief headquarter, and the water level sensing monitoring information of the power facility body.

Specifically, the safety access layer is used for acquiring the flooding emergency response notification, the heavy rainfall defense alarm information (including emergency response levels, early warning regions and precipitations) and the flood risk map issued on the website of a provincial flood control and drought relief headquarter through a preacquisition server, and the liquid level sensing information (liquid level height data and liquid level monitoring time) of the power facility body. Data of the flooding emergency response notification and the heavy rainfall defense alarm information (including emergency response levels, early warning regions and precipitations) from the provincial flood control and drought relief headquarter are based on provisions of GB/T 50138 Standard for Stage Observation, the safety access layer switches data with the website of the provincial flood control and drought relief headquarter with reference to relevant provisions of SL/Z 388 Protocol for Exchange of Real-time Hydrological Information, and interface specifications of the safety access layer with the website of the flood control and drought relief headquarter and the liquid level sensor of the power facility body conform to relevant provisions of Q/CSG 1204012 Technology Specification for Communication Network Production Application Interface. Meanwhile, the preacquisition server is located in a safety access area, and the safety access area can meet network safety requirements for accessing data in communication modes of communication networks (excluding the Internet) and wireless communication networks (GPRS, CDMA, 230 Mhz, WLAN, etc.).

Preferably, data exchange refers to transmission, receiving, interpretation and analysis of data.

Preferably, the throughput of a safety access layer isolation gateway to the website of the flood control and drought relief headquarter and the relevant data of the liquid level sensor is greater than 600 megabits per second, and the system delay is less than 100 milliseconds.

The acquisition layer is used for acquiring relevant information of a power geographic information map.

Specifically, the acquisition layer is used for acquiring the power geographic information map and the graphic code thereof from a power geographic information system of a power enterprise by means of data acquisition server, acquiring power facility account information from a power grid management platform of the power enterprise, and location information and flood control standard information of each affected power facility region. facility spatial geographic attribute information processing and information exchange code from the power geographic information system refer to provisions of DL/T 397 Classification and Coding of the Symbol in Electric Power Geographic Information System, and the acquisition layer and the power geographic information system exchange data with reference to GB/T 17798 Geospatial Data Transfer Format. At the same time, the interface specification between the acquisition layer and the power geographic information system and the power grid management platform conforms to relevant provisions of Q/CSG 1204012 Technical Specification for Communication Network Production Application Interface.

The data layer is used for storing data processed by the flooding water level monitoring system for power facilities.

Specifically, the data layer includes two parts, namely a real-time database server, and a relational database server, for storing data related to the flooding height, degree and time monitoring result in the affected power facility region. The relational database is used for storing the power geographic information map and the graphic code and the flood risk map thereof of the power geographic information system, the power facility account information from a power grid management platform, and location information and flood control standard information of each affected power facility region; and the real-time database is used for storing the flooding emergency response notification, the heavy rainfall defense alarm information, and the liquid level sensing monitoring information of the power facility body.

The processing layer is used for after receiving the flooding emergency response notification and the heavy rainfall defense alarm, starting the flooding water level monitoring process for power facilities; according to the flooding emergency response notification and the heavy rainfall defense alarm, judging whether the power facility region is affected, and when the power facility region is affected, issuing the early warning notification, and taking the next step; according to the electric power geographic information map, determining the boundary range at the location of the power facilities belonging to the water-logging region, and calculating the individual area of the power facilities and the total area of the power facilities affected by flooding; according to the individual area of the power facilities and the total area of the power facilities affected by flooding and water level sensing monitoring information of the power facility body, establishing the neural network measuring an affected range of the power facility region, and outputting the flooded surface height monitoring result at the location of the power facilities;
an application layer, for displaying the flooded surface height monitoring result at the location of the power facilities and relevant data output by the processing layer, and carrying out data transmission through a website server.

Specifically, the application layer is used for outputting the real-time map displaying the range of the affected power facility region, and used for issuing the emergency response level, the flooded surface height level, the flooded surface height Ē of the affected power facility region, the flooding time T monitoring result, and corresponding real-time monitoring map of the affected power facility region for technicians of production technology, security supervision, scheduling operation, marketing, supply chain, scientific research and power grid planning departments through the website server.

As an optional embodiment, the preacquisition server, the data acquisition server, the application server, the database server and the website server are deployed in the data center machine room of the provincial power grid company production command center.

As an optional embodiment, the preacquisition server and the data acquisition server are respectively NF5270M5 2U rack-mounted servers with four 8-core Xeon E7 V4 series CPUs.

As an optional embodiment, the application server is an NF5270M5 2U rack-mounted server with four 10-core to strong Xeon-silver series CPUs.

As an optional embodiment, the database server and the website server are both NF5180M5 1U rack-mounted servers with two 8-core Xeon E7 V4 series CPUs.

As an optional embodiment, the delay that a user logs in to visit the application layer website server is not longer than 2 seconds.

As an optional embodiment, after acquiring the flooded surface height Ē and the flooding time T monitoring result of the affected power facility region, the application layers can output the display map of the power facility flooding water level monitoring within 60 seconds in real time.

The present invention is not limited in the specific embodiments above, but the above descriptions are only preferred embodiments of the present invention, and are not intended to limit the present invention. Any modifications, equivalent replacements, improvements, etc. made within the spirit and principles of the present invention shall be included in the protection scope of the present invention.

### Embodiment 3

According to another aspect of the embodiment of the present invention, a flooding water level monitoring system for power facilities is also provided. FIG. 3 is the schematic diagram of the flooding water level monitoring system for power facilities according to the embodiment of the present invention. As shown in FIG. 3, the system includes: a liquid level sensor, a preacquisition server, a data acquisition server, a real-time database server, a relational database server, an application server, a website server, an engineer station, an operator station, an intranet switch, an extranet switch, and a firewall. The liquid level sensor is deployed at a power facility body to be monitored, and is connected with the preacquisition server through a wireless communication network; and the remaining facilities are connected to each other through a power integrated data network and deployed in a provincial power grid company production command center.

The liquid level sensor is deployed at the site, and is used for monitoring the flooding height Eᵢ and the flooding time T of the power facility body. The liquid level sensor includes: resistance liquid level sensors, capacitive liquid level sensors, inductive liquid level sensors and strain resistance liquid level sensors. The output modes are: analog output, digital output, analog and digital mixed output, in a total of three output modes. The accuracy levels include: 0.05,0.1, 0.25, 0.5, 1, 2.5, and 5, in a total of seven levels. The basic parameters, requirements, test methods and test rules conform to relevant provisions of JB/T 12598 Input Liquid Level Sensor.

The extranet switch and the firewall are deployed in the communication machine room of the provincial power grid company production command center, and is used for exchanging and scanning data and instructions with the website of the provincial flood control and drought relief headquarter at the location, and data exchange and analysis conform to relevant provisions of SL/Z 388 Protocol for Exchange of Real-time Hydrological Information.

The preacquisition server, the data acquisition server, the real-time database server, the relational database server, the application server and the website server are all one set in terms of number, and are deployed in the data center machine room of the provincial power grid company production command center.

The preacquisition server and the data acquisition server of the flooding monitoring system are both NF5280M5 2U rack-mounted servers, equipped with four 8-core Xeon E7 V4 series CPUs, supporting hyperthreading, with a cache of no less than 25 megabytes and an original frequency of no less than 1.9 GHZ. The memory configured is a DDR4 memory not less than 128 gigabytes, and the maximum total number of memory slots is not less than 64. The hard discs configured are 4 serially connected SCSI hard discs of 600 gigabytes and 12000 rpm. The network card is equipped with eight independent 10/100/1000M-BaseT Ethernet ports.

The website server and the database server of the flooding monitoring system are both NF5280M5 2U rack-mounted servers, equipped with two 8-core Xeon E7 V4 series CPUs, supporting hyperthreading, with a cache of no less than 25 megabytes and an original frequency of no less than 1.9 GHZ. The memory configured is a DDR4 memory not less than 128 gigabytes, and the maximum total number of memory slots is not less than 64. The hard discs configured are four serially connected SCSI hard discs of 600 gigabytes and 12000 rpm. The network card is equipped with eight independent 10/100/1000M-BaseT Ethernet ports.

The preacquisition server loads the safety access layer, is one set in terms of number, and is deployed in the data center machine room of the provincial power grid company production command center. The data exchange, customization protocol, deployment architecture, data transmission security specification and protection mechanism thereof should conform to provisions of Q/CSG 1210017 Technical Specification for Internal and External Network Data Security Exchange Platform, Q/CSG 1210007 Data Transmission Security Standard and Q/CSG 1204009 Technical Specification for Security Protection of Power Monitoring System. The flooding emergency response notification, the heavy rainfall defense alarm information (including emergency response levels, early warning regions and precipitations) and the flood risk map issued on the website of the provincial flood control and drought relief headquarter, the flooding height Eᵢ and the flooding time T of the power facility body acquired by the liquid level sensor are collected through the extranet switch, and data service is provided for the relational database server and the real-time database server. The preacquisition server scans exchanged data and instructions through the firewall, closes abnormal ports to prevent invasion, and collects the flooding emergency response notification, the heavy rainfall defense alarm information (including emergency response levels, early warning regions and precipitations) and the flood risk map from the website of the provincial flood control and drought relief headquarter, and the format of information such as the time, the early warning region and the precipitation, or other elemental fields and identifications, conforms to the provisions of SL/T 591 Structure and Identifiers for Database of Historical Large Floods.

The data acquisition server loads the acquisition layer, is one set in terms of number, and is deployed in the data center machine room of the provincial power grid company production command center. The data exchange, customization protocol, deployment architecture, data transmission security specification and protection mechanism thereof should conform to provisions of Q/CSG 1210017 Technical Specification for Internal and External Network Data Security Exchange Platform, Q/CSG 1210007 Data Transmission Security Standard and Q/CSG 1204009 Technical Specification for Security Protection of Power Monitoring System. The power geographic information map (including the power plant 1000000, the transmission corridor 3010000, the substation 2000000, and the power supply region 6030000) in a middleware server of the power geographic information system, and relevant information (including account information, and location information and flood control standard information of each affected power facility region) of the power facilities in the power grid management platform are acquired through the intranet switch, and data service is provided for the relational database server.

The database server loads the data layer, includes one real-time database server and one relational base data server, is deployed in the data center machine room of the provincial power grid company production command center, and is used for storing the flooding height monitoring result and relevant data required by the flooding time monitoring result of the affected power facility region. The data exchange, customization protocol, data transmission security specification and protection mechanism thereof should conform to provisions of GB/T 20273 Security Techniques Requirement for Database Management System, and Q/CSG 1210007 Data Transmission Security Standards. The relational database server is used for storing the flood risk map issued on the website of the provincial flood control and drought relief headquarter, the power geographic information map in the middleware server of the power geographic information system, relevant information of the power facilities in the power grid management platform, and the power grid flood prevention emergency response level. The real-time database server is used for storing the flooding emergency response notification and the heavy rainfall defense alarm information issued on the website of the provincial flood control and drought relief headquarter, and the liquid level sensing monitoring data of the power facility body, and data service is provided for the application server through the intranet switch.

The application server loads the processing layer, is one set in terms of number, and is deployed in the data center machine room of the provincial power grid company production command center. The server is of an NF5270M5 2U rack type, and is equipped with four 10-core to Xeon-silver series CPUs, supporting hyperthreading, with a cache of no less than 20 megabytes and an original frequency of no less than 2.0 GHz. The memory configured is a DDR4 memory not less than 128 gigabytes, and the maximum total number of memory slots is not less than 64. The hard discs configured are two serially connected SCSI hard discs of 600 gigabytes and 12000 rpm.

The neural network for solving conditions of the affected power facility region through the deployment of the application server inputs the flooding emergency response notification and the heavy rainfall defense alarm issued by the provincial flood control and drought relief headquarter, the liquid level sensing information of the power facility body, the individual area Sᵢ of the affected power facilities and the total area Sₙ of the power facilities at a specific moment into the input layer; measures the flooded surface height Ē and the flooding time T in the affected power facilities, and the flooded surface height levels in real time at the implication layer; outputs the real-time monitoring result map about the flooded surface height Ē and the flooding time T and displaying a corresponding flooding water level of the power facilities; and provides data service for the website server through a switch. The flooding height Eⱼ is obtained according to a measurement value of the liquid level sensor deployed at the power facility body, and furthermore the flooded surface height Ē is calculated; and according to the flood control standard of power facilities in the GB 50201 Standard for Flood Control, the flooded surface height level are obtained, and according to the time that the flooded surface height level reaches the level IV flood control standard, the flooding time T′is obtained.

The website server loads the application layer, is one set in terms of number, and is deployed in the data center machine room of the provincial power grid company production command center. The access technology measures thereof should conform to provisions of Q/CSG 1204009 Technical Specification for Safety Protection of Power Monitoring System, the management measures should conform to provisions of Q/CSG 212001 Administrative Measures for Safety Protection of Power Monitoring System, relevant elements of the map of an early warning service graph, the display map and the like should conform to QX/T 481 Graphic of Meteorological Risk Warning Service for Small and Medium-sized River Flood, Flash Flood and Geological Hazard Induced by Heavy Rain, and DL/T 397 Classification and Coding of the Symbol in the Electric Power Geography Information System, and the graphic requirements and layout of the display map output to show the individual area Sᵢ and the total area Sₙ of each affected power facility of the flooded surface height Ē at the flooding time T conform to provisions of SL/T 483 Guidelines for Flood Risk Mapping. A flooding disaster data monitoring service is provided for power production command decision-making and emergency response personnel of different levels through the intranet switch. When a user visits the website server of the flooding monitoring system at the location of the affected power facilities, the access verification of the system to the user should conform to provisions of GB/T 20272 Security Technical Requirements for Operating System.

The intranet switch is one set in terms of number, and is deployed in the communication machine room of the provincial power grid company production command center. The requirements on physical interfaces, protocols and intercommunication and compatibility of the intranet switch should conform to provisions of Q/CSG 1204016.3 Part 3: Technical Specification for Data Network of CSG, for connecting the data acquisition server, the relational database server, the application server, the website server, the engineer station, the operator station, the extranet switch and the firewall through the power integrated data network consisting of optical cable fibers.

The extranet switch is one set in terms of number, is deployed in the communication machine room of the provincial power grid company production command center, and is equipped with 24 10/100/1000 megabytes adaptive electrical ports. The switching capacity is not less than 150 megabits/second. The packet forwarding capacity of the second and third layers is not less than 95 megabits/second. The number of concurrent flow statistics is not less than 400,000. The data packet forwarding delay is less than 1 millisecond, and LDP MD5, VRRP MD5, NTP MD5 encryption authentication is supported. The extranet switch is used for connecting a prepositive server and the real-time database server through the power integrated data network consisting of optical cable fibers.

The firewall is one set in terms of number, and is deployed in the communication machine room of the provincial power grid company production command center. The firewall has an access control function and a logic isolation function.

The engineer station is one set in terms of number, and is deployed in the monitoring room of the provincial power grid company production command center, as a dual-channel working station of the ThinkStation P920 series.

The configuration principle and the technical requirements of the engineer station should conform to the requirements of Q/CSG 1203005 Technical Guide for Electric Power Secondary Equipment about a computer monitoring system, and are used for providing service for system administrators to maintain the flooding monitoring system.

The operator station is one set in terms of number, and is deployed in the monitoring room of the provincial power grid company production command center, as a working station of the ThinkStation K series.

The configuration principle and the technical requirements of the engineer station and the operator station should conform to the requirements of Q/CSG 1203005 Technical Guide for Electric Power Secondary Equipment about a computer monitoring system, and are used for providing technical service for load transfer, flood control reinforcement, emergency repair of electric power, material allocation, customer service and early warning degrees for system administrators and operator on duty.

Requirements on physical interfaces, protocols, intercommunication and compatibility of the extranet switch with the database server, the prepositive server, the data acquisition server, the application server, the website server, the engineer station, the operator station and the intranet switch of the flooding monitoring system should conform to provisions of Q/CSG 1204016.3 Part 3: Technical Specification for Data Network, and requirements on configuration, setup and partitioning of the liquid level sensor, the real-time database server, the rational database server, the preacquisition server, the data acquisition server, the application server, the website server, the engineer station, the operator station, the intranet switch, the extranet switch and the firewall should conform to provisions of Q/CSG 212001 Administrative Measures for Safety Protection of Power Monitoring System and Q/CSG 1204009 Technical Specification for Safety Protection of Power Monitoring System. Main performance indicators of the flooding monitoring system should conform to provisions of GB/T 16260.2 Software Engineering Product Quality Part 2: Internal Metrics, GB/T 1 6260.3 Software Engineering Product Quality Part 3: External Metrics, and Q/CSG 1204016.3 Data Network Technical Specifications Part 3 Technical Specification for Data Network. Security function requirements of the flooding monitoring system should conform to provisions of GB/T 20271 Information Security Technology Common Security Techniques Requirement for Information System.

In the specific installation and deploying process of the flooding monitoring system, first, the liquid level sensor is deployed at the site of the power facilities. Secondly, the preacquisition server, the data acquisition server, the relational database server, the real-time database server, the application server and the website server are deployed in a shielding cabinet in the data center machine room of the provincial power grid company production command center, and the number of each device is one and only one. Thirdly, the intranet switch, the extranet switch and the firewall are deployed in the shielding cabinet in the communication machine room of the provincial power grid company production command center, and the number of each device is one and only one. After identity identification and data encryption, the flooding emergency response notification and the heavy rainfall defense alarm information of the provincial flood control and drought relief headquarter, and the liquid level sensing information of the power facility body are acquired through the extranet switch and the firewall, and the power geographic information map of the power geographic information system and relevant information of power facilities of the power grid management platform are acquired through the extranet switch. Finally, the engineer station and the operator station are deployed in the monitoring room of the provincial power grid company production command center, the number of the engineer station is one and only one, and the number of the operator station is two, for remotely monitoring results of the power facilities suffering from flooding.

A power grid company, as the member unit of the flood control and drought relief headquarter, after receiving the flooding emergency response notification and the heavy rainfall defense alarm issued by the local flood control and drought relief headquarter, for disasters such as storm flood, torrential flood, snowmelt flood, ice flood and dam bursting flood, starts the flooding water level monitoring process for the power facilities in accordance with requirements of the flooding emergency plan for preventing typhoon flooding and drought, does a good job in power supply to the affected region at the location of the power facilities, gives priority to the emergency power use for flood control and emergency rescue, strictly implements the annual flood control and operation plan of large reservoirs (hydropower stations) issued by the flood control and drought relief headquarter, and cooperates with the hydropower stations to do a good job in flood control and safety dispatching. In the specific monitoring and early-warning process of the flooding water level monitoring system for power facilities, first the provincial flood control and drought relief headquarter starts the flood forecasting process in accordance with provisions of SL 250 Standard for Hydrological Information and Hydrological Forecasting and GB/T 50138 Standard for Stage Observation, to observe hydrological situations. Secondly, technical personnel of the provincial power grid company production command center starts the emergency response level and plan, and starts precasting process of the range of affected power facility region of in accordance with provisions of SL 250 Standard for Hydrological Information. Thirdly, power facilities of the power geographic information map in the power geographic information system are searched and judged. Under the spatial correlation rule, whether the affected power facility region is in the boundary range of the water-logging region is judged according to spatial geographic attribute information. In the flooding monitoring system, the graphic code of the affected power facility region is 7020004, and furthermore the individual area Sᵢ of the affected power facilities and the total area Sₐ of the power facilities are obtained and displayed. Fourthly, the flooding monitoring system, according to the liquid level sensing monitoring information and the like of the power facility body, solves the flooding height monitoring result and the flooding time monitoring result of the affected power facility region, outputs a display map (general view) at the location of the affected power facilities, and issues the monitoring result of the flooded surface height Ē and the flooding time T of the corresponding affected power facility region in accordance with provisions of QX/T 549 Specifications for Meteorological Disaster Early-warning Message Dissemination on Website, thereby monitoring and judging flooding development situations in real time. Finally, a technical decision-making proposal for emergency repair of electric power for affected power outage users is offered by technical personnel of the provincial and local production command centers in accordance with operation control principles and goals specified in DL/T 1883 Operation and Control Specifications for Distribution Network, Q CSG 1205003 Management Standards of Distribution Operation and Q/CSG 430043 Evaluate Service Instructions after Emergency Handling, and are disposed by technical personnel of related power supply bureaus, and if necessary, measures such as in-disaster operation mode adjustment, after-disaster emergency repair of electric power, and new flood and drought control reinforcement, can be taken.

Main measures in the specific disposing process are as follows:

In an exemplary embodiment, the provincial power grid company production command center, together with production technical departments, solves the monitoring result of the flooded surface height Ē and the flooding time of the affected power facility region for user power supply and distribution facilities (referring to electric equipment and power facilities from a property demarcation point to a electrical load, including distribution transformers, overhead lines, cables and the like and auxiliary electric equipment and facilities thereof) suffering from flooding, based on the spatial geographic attribute information of the power distribution facilities in the affected power facility region, the flooding emergency response notification, the heavy rainfall defense alarm information (including emergency response levels, early warning regions and precipitations) and the flood risk map issued on the website, and the liquid level sensing monitoring information of the power facility body, and offers emergency measures and proposals for emergency repair of electric power, and the like.

In an exemplary embodiment, the provincial power grid company production command center, together with security supervision departments, after receiving the flooding emergency response notification and the heavy rainfall defense alarm issued by the local flood control and drought relief headquarter, and the flood risk map, judges the early-warning levels of flooding water level monitoring at the location of the power facilities in accordance with the individual area Sᵢ of the affected power facilities and the total area Sₙ of the power facilities, and issues early warning notification of level I to level IV emergency response to relevant prefecture-level power supply bureaus.

In an exemplary embodiment, the provincial power grid company production command center, together with power scheduling departments, instructs power grid company production departments at the location of the power facilities to take emergency facility outage measures in the principle of ‘water rises and electricity stops, and water retreats and electricity recovers’ according to the flooded surface height Ē for the individual area Sᵢ of the affected power facilities and the total area Sₙ of the power facilities, to serve flooding control and disaster relief, and according to the flooding time T, predicts the flood evolution trend, and takes load transfer measures, thereby ensuring safe and stable operation of the power system.

In an exemplary embodiment, a prefecture-level power grid company production command center, together with marketing departments, instructs power supply branches and power supply stations belonging to the prefecture-level power supply bureau to judge user power supply and distribution facilities at the lasting outage state (that is, the lasting outage time is longer than 3 minutes) by using the flooding water level monitoring system of the power facilities in the range of the affected power facility region, and in combination of a water-logging risk distribution map and operation experience thereof, comprehensively organizes troubleshooting on power distribution facilities affected by water logging and immersion. Mainly for the monitoring result of the flooded surface height Ē and the flooding time T at the location of the power facilities, relevant decision-making proposals for the sequence of emergency repair of electric power at different regions are offered. For affected power facility region belonging to power user properties, technical personnel of related power supply bureaus offer early warning notifications, and instruct or cooperate to take emergency disposing measures in accordance with relevant provisions of GB/T 37136 Specification of Operation and Maintenance for Power User's Power Supply and Distribution facilities. The power supply bureau provides technical support for emergency repair of electric power for users, and users mainly refer to low voltage users receiving power of the voltage 380V/220V, medium voltage users receiving power of 10 (6, 20) kv, and high voltage users receiving power of 35 kv or higher. After heavy rainfall, the flooding water level monitoring system of the power facilities also assists technical personnel of the power supply bureau in solving the average number of outage users and average outage time of outage users. The average number of outage users refers to the number of users in each outage, marked as (user/time) during a statistic period. The average outage time of outage users refers to the average outage time of outage users during the statistic period, marked as (time/user).

In an exemplary embodiment, the provincial power grid company production command center, together with supply chain departments, combs power facilities that the flooded surface height reaches the level IV in the range of the affected power facility region, and allocates emergency rescue materials such as different power distribution transformers (oil immersed type, and dry type), overhead power distribution line fittings and concrete electric poles according to disaster situations in accordance with the power facility account information of the power grid management platform, thereby supporting emergency repair for electric power.

In an exemplary embodiment, after a flooding disaster, technical personnel and scientific researchers in the provincial power grid company production command center selects no less than 20 power distribution line pole towers, 20 power transmission line fields and obvious target points (testing points) of other facilities on the power geographic information map by using the engineer station, and calculates testing errors of the flooding monitoring system at the location of the affected power facilities by comparing with coordinates of target points (testing points) of the same name on a remote-sensing image plane graph of the flooding height of the affected power facility region, thereby continuously iterating, upgrading and completing the monitoring system. Calculation formula:

$${m}_{s} = \pm \sqrt{\frac{{\sum }_{a = 1}^{y} ( Δ {u}_{a}^{2} - Δ {v}_{\overline{y}}^{2} )}{y}}$$

In the formula, mₛ refers to a mean square error of a point (mm), Δu and Δv are both coordinate errors (mm) of testing points, and y is the number (piece) of testing points, and is not less than 20.

In an exemplary embodiment, the provincial power grid company production command center, together with power grid planning departments, combs flooded surface heights at the location of power facilities in each round of flooding, and adjusts flood control standards according to recurrence intervals at the location, thereby providing decision-making information for planning, transformation and reinforcement for flood control of power facilities.

### Embodiment 4

According to another aspect of the embodiment of the present invention, a computer readable storage medium is also provided, the computer readable storage medium includes a stored program, wherein the program, when running, controls equipment with the computer readable storage medium to execute the flooding water level monitoring method for power facilities according to any one of the claims.

Optionally, in the embodiment, the computer readable storage medium can be located in any computer terminal in a computer network terminal group, or in any mobile terminal in a mobile terminal group. The computer readable storage medium includes the stored program.

Optionally, a device with the computer readable storage medium is controlled to execute the following functions when the program runs: after receiving the flooding emergency response notification and the heavy rainfall defense alarm, starting the flooding water level monitoring process for power facilities; inputting the flooding emergency response notification and the heavy rainfall defense alarm, judging whether the power facility region is affected, and when the power facility region is affected, issuing the early warning notification, and taking the next step; inputting the power geographic information map, determining the boundary range at the location of the power facilities belonging to the water-logging region, and calculating the individual area of the power facilities and the total area of the power facilities affected by flooding; inputting the water level sensing monitoring information of the power facility body affected by flooding; according to the individual area of the power facilities and the total area of the power facilities affected by flooding and water level sensing monitoring information of the power facility body, establishing the neural network measuring the affected range of the power facility region, and outputting the flooded surface height monitoring result at the location of the power facilities.

The serial numbers of the embodiments of the present invention are only for description, and do not represent the advantages and disadvantages of the embodiments.

In the above embodiments, the description of the embodiments has respective emphasis, and referring to the relevant description of the other embodiments for the parts which are not described in detail in a certain embodiment.

In the several embodiments provided in the present application, it should be understood that the disclosed technical contents may be realized in other manners. The system embodiments described above are merely schematic, for example, the division of the units may be merely a logical function division, and there may be other division manners in actual realization, for example, a plurality of units or components may be combined or integrated into another system, or some features may be ignored or not executed. Another point is that the mutual coupling or direct coupling or communication connection shown or discussed may be indirect coupling or communication connection of the apparatuses or units through some interfaces, and may be electrical or in other forms.

The units described as separate components may or may not be physically separated, and the components displayed as units may or may not be physical units, that is, the components may be located in one place, or may be distributed to a plurality of network units. Part or all of the units may be selected according to actual needs to realize the objectives of the solutions of the embodiments.

In addition, various functional units in various embodiments of the present invention may be integrated in one processing unit, or each unit may exist individually and physically, or two or more units may be integrated in one unit. The integrated units may be implemented in a form of hardware, and may also be implemented in a form of a software function unit.

The integrated unit, if implemented in the form of a software functional unit and sold or used as a stand-alone product, may be stored in a computer readable storage medium. Based on this understanding, the technical solution of the present invention essentially or a part that contributes to the prior art; or part of the technical solution may be embodied in a form of a software product; and the computer software product is stored in a storage medium and includes a plurality of instructions which are used to enable a computer device (which may be a personal computer, a server, or a network device, etc.) to execute all or part of the steps of the methods described in the various embodiments of the present invention. The storage media includes: a USB flash disk, a read-only memory (ROM), a random access memory (RAM), a mobile hard disk, a magnetic disk, an optical disk or other media that can store program codes.

Described above are merely preferred implementations of the present invention. It should be pointed out that many improvements and modifications can be made for those of ordinary skill in the art without departing from the principle of the present invention, and these improvements and modifications shall fall into the scope of protection of the present invention.

What is claimed is:

1. A flooding water level monitoring method for power facilities, comprising:
after receiving a flooding emergency response notification and a heavy rainfall defense alarm, starting a flooding water level monitoring process for power facilities;
inputting the flooding emergency response notification and the heavy rainfall defense alarm, judging whether a power facility region is affected, and when the power facility region is affected, issuing an early warning notification, and taking a next step;
inputting a power geographic information map, determining the boundary range at the location of the power facilities belonging to a water-logging region, and calculating the individual area of the power facilities and the total area of the power facilities affected by flooding;
inputting water level sensing monitoring information of a power facility body affected by flooding; and
according to the individual area of the power facilities, the total area of the power facilities and the water level sensing monitoring information of the power facility body affected by flooding, establishing a neural network measuring an affected range of the power facility region, and outputting the flooded surface height monitoring result at the location of the power facilities.

2. The flooding water level monitoring method for power facilities according to claim 1, wherein the flooded surface height monitoring result at the location of the power facilities comprises: the individual area, the total area, the flooded surface height, the flooding time and the affected level at the location of the power facilities affected by flooding.

3. The flooding water level monitoring method for power facilities according to claim 1, wherein according to a flooding emergency response notification, heavy rainfall defense alarm information and a flood risk map in the flooding emergency response notification and the heavy rainfall defense alarm, judging whether the power facility region is affected.

4. The flooding water level monitoring method for power facilities according to claim 1, wherein the water level sensing monitoring information of the power facility body is obtained through measurement of a liquid level sensor.

5. The flooding water level monitoring method for power facilities according to claim 1, wherein the expression that the neural network measuring the affected range of the power facility region calculates the flooded surface height Ē at the location of the power facilities is:
$$\overline{E} = \frac{1}{{S}_{n}} \sum {μ}_{i} {E}_{i} {dS}_{i}$$
In the expression, Sₙ refers to the total area of the power facilities affected by flooding, dSᵢrefers to the individual area of the power facilities affected by flooding, Eᵢ refers to the flooding height of the power facilities, and μᵢ refers to the weight of different region types.

6. The flooding water level monitoring method for power facilities according to claim 5, wherein the weight corresponding to μᵢ is set according to the accuracy level of the liquid level sensor.

7. The flooding water level monitoring method for power facilities according to claim 2, wherein the affected level of the region is determined according to the flooded surface height of the power facilities affected by flooding.

8. A flooding water level monitoring system for power facilities, comprising:
a safety access layer, for receiving a flooding emergency response notification and a heavy rainfall defense alarm issued on the website of a local flood control and drought relief headquarter, and water level sensing monitoring information of a power facility body;
an acquisition layer, for acquiring relevant information of a power geographic information map;
a data layer, for storing data processed by the flooding water level monitoring system for power facilities;
a processing layer, for after receiving the flooding emergency response notification and the heavy rainfall defense alarm, starting a flooding water level monitoring process for power facilities; according to the flooding emergency response notification and the heavy rainfall defense alarm, judging whether a power facility region is affected, and when the power facility region is affected, issuing an early warning notification, and taking a next step; according to the electric power geographic information map, determining the boundary range at the location of the power facilities belonging to a water-logging region, and calculating the individual area of the power facilities and the total area of the power facilities affected by flooding; according to the individual area of the power facilities and the total area of the power facilities affected by flooding and the water level sensing monitoring information of the power facility body, establishing a neural network measuring an affected range of the power facility region, and outputting the flooded surface height monitoring result at the location of the power facilities; and
an application layer, for displaying the flooded surface height monitoring result at the location of the power facilities and relevant data output by the processing layer, and carrying out data transmission through a website server.

9. A computer readable storage medium, comprising a stored program, wherein the program, when running, controls equipment with the computer readable storage medium to execute the flooding water level monitoring method for power facilities according to claim 1.
